(19) United States
(12) Patent Application Publication
(10) Pub. No.: US 2026/0168791 A1
(43) Pub. Date: Jun. 18, 2026

(54) DEVICE AND METHOD FOR MONITORING SEMICONDUCTOR PACKAGING PROCESS USING TERAHERTZ WAVE

(71) Applicant: IUCF-HYU (INDUSTRY-UNIVERSITY CORPORATION FOUNDATION HANYANG UNIVERSITY), Seoul (KR)

(72) Inventors: Hak Sung KIM, Seoul (KR); Sang Il KIM, Seoul (KR); Heon Su KIM, Seoul (KR)

(73) Assignee: IUCF-HYU (INDUSTRY-UNIVERSITY CORPORATION FOUNDATION HANYANG UNIVERSITY), Seoul (KR)

(21) Appl. No.: 19/529,551

(22) Filed: Feb. 4, 2026

Related U.S. Application Data
(63) Continuation of application No. PCT/KR2024/006737, filed on May 17, 2024.

(30) Foreign Application Priority Data
Sep. 4, 2023 (KR) 10-2023-0116892

(51) Int. Cl. G01B 11/27; G01B 11/16

(52) U.S. Cl. CPC G01B 11/272; G01B 11/16

(57) ABSTRACT

An apparatus for monitoring a semiconductor packaging process by using terahertz waves is provided. The apparatus for monitoring a semiconductor packaging process by using terahertz waves may comprise; an emitter which emits terahertz waves toward a semiconductor package; a detector which detects terahertz waves emitted from the emitter and reflected from the semiconductor package or terahertz waves penetrating the semiconductor package; and a monitoring unit which, during a packaging process for the semiconductor package, monitors a state of the semiconductor package in real time on the basis of the terahertz waves detected by the detector, wherein the state of the semiconductor package includes at least one of misalignment due to two-dimensional translation of a semiconductor chip, misalignment due to two-dimensional rotation of the semiconductor chip, deformation due to three-dimensional tilt of the semiconductor chip, and deformation due to three-dimensional warpage of the semiconductor package.

### CROSS REFERENCE TO RELATED APPLICATIONS

This application is a Bypass continuation of International Application No. PCT/KR2024/006737, filed on May 17, 2024, which claims priority from Korean Application No. 10-2023-0116892, filed on Sep. 4, 2023, the contents of all of which are incorporated herein by reference in their entirety.

### TECHNICAL FIELD

The present invention relates to a device and a method for monitoring a semiconductor packaging process using a terahertz wave, and more specifically, to a device and a method for monitoring a semiconductor packaging process using a terahertz wave so as to monitor a state of a semiconductor package in real time using a terahertz wave during the semiconductor packaging process.

### BACKGROUND ART

An epoxy molding compound (EMC) molding process performed in a semiconductor packaging process is carried out at high temperature and high pressure, which causes a misalignment problem due to internally moving chips and a warpage problem of a package. Further, in the case of process of continuously moving chips such as a die attach process or a re-distribution layer (RDL) process, process defects continuously occur due to alignment errors of the chips.

The above problems become even more critical in advanced semiconductor packaging processes using large-area wafers such as panel level packages (PLPs) and wafer level packages (WLPs). However, there are limitations in that these process problems cannot be detected by existing inspection technologies.

For example, a laser scanning inspection scheme may have a limitation in inspecting the inside of a product formed of a transparent material.

In addition, an ultrasound inspection scheme may have a limitation in inspecting an electronic product because the product is immersed in water, and have a limitation in resolution for inspecting a highly integrated product.

In addition, an X-ray inspection scheme may have a limitation in real-time inspection of products in a semiconductor packaging process performed at high speed because the inspection time is taken long, and have a limitation in that ionizing radiation generated during the inspection has a negative effect on the human body of a measuring person and the products.

### DISCLOSURE

### Technical Problem

One technical problem to be solved by the present invention is to provide a device and a method for monitoring a semiconductor packaging process using a terahertz wave so as to monitor a state of a semiconductor package in real time using terahertz waves during the semiconductor packaging process.

The technical problems to be solved by the present invention are not limited to the above description.

### Technical Solution

In order to solve the above-mentioned technical problems, the present invention provides a device for monitoring a semiconductor packaging process using a terahertz wave.

According to one embodiment, the device for monitoring a semiconductor packaging process using a terahertz wave includes: an emitter for generating a terahertz wave toward a semiconductor package; a detector for detecting a terahertz wave generated from the emitter and reflected from the semiconductor package or a terahertz wave transmitted through the semiconductor package; and a monitoring unit for monitoring a state of the semiconductor package in real time based on the terahertz wave detected by the detector during the packaging process for the semiconductor package, wherein the state of the semiconductor package may include at least one of a misalignment due to two-dimensional translation of a semiconductor chip, a misalignment due to two-dimensional rotation of the semiconductor chip, a deformation due to three-dimensional tilting of the semiconductor chip, and a deformation due to a three-dimensional warpage of the semiconductor package.

According to the one embodiment, the semiconductor package may have at least one detection point set at which the terahertz wave emitted from the emitter is detected by the detector, and the at least one detection point may include at least one border point set on a border of the semiconductor chip.

According to the one embodiment, the monitoring unit may monitor the state of the semiconductor package in real time through one monitoring mode selected from among a first monitoring mode for monitoring in real time a presence of the misalignment due to the two-dimensional translation of the semiconductor chip; a second monitoring mode for monitoring in real time a presence of the misalignment due to the two-dimensional rotation of the semiconductor chip; a third monitoring mode for monitoring in real time a presence of the deformation due to the three-dimensional tilting of the semiconductor chip; and a fourth monitoring mode for monitoring in real time a presence of the deformation due to the three-dimensional warpage of the semiconductor package, wherein when the one monitoring mode among the first to fourth monitoring modes is selected, a detection position and a detection number for the at least one detection point may be automatically defined.

According to the one embodiment, the border point may be set at a position in which a portion of a section of the terahertz wave detected by the detector overlaps with the semiconductor chip.

According to the one embodiment, the first monitoring mode is configured to determine the presence of the misalignment due to the two-dimensional translation of the semiconductor chip through an increase or decrease in reflectance of the terahertz wave detected from the at least one detection point defined as the detection position, such that a degree of the two-dimensional translation of the semiconductor chip may be calculated through an increase or decrease in reflectance of a terahertz wave detected in each of at least three border points, and the second monitoring mode is configured to determine the presence of the misalignment due to the two-dimensional rotation of the semiconductor chip through the increase or decrease in reflectance of the terahertz wave detected from the at least one detection point defined as the detection position, such that a degree of the two-dimensional rotation of the semiconductor chip may be calculated through an increase or decrease in reflectance of a terahertz wave detected in each of at least two border points.

According to the one embodiment, when the misalignment due to the two-dimensional translation of the semiconductor chip is confirmed and the degree of the two-dimensional translation of the semiconductor chip is calculated through the first monitoring mode, a subsequent process condition may be adjusted to correspond to the misalignment due to the two-dimensional translation of the semiconductor chip.

According to the one embodiment, the third monitoring mode may be configured to calculate a degree of the deformation due to the three-dimensional tilting of the semiconductor chip through a detection time difference of terahertz waves detected in the at least one detection point defined as the detection position, and the fourth monitoring mode may be configured to calculate a degree of the deformation due to the three-dimensional warpage of the semiconductor package through the detection time difference of the terahertz waves detected in the at least one detection point defined as the detection position.

According to the one embodiment, the monitoring unit may monitor the state of the semiconductor package through a scan mode and a precision mode, the scan mode may be configured to detect terahertz waves at minimum detection points among the at least one detection point, and the monitoring unit, when detecting an abnormality in the state of the semiconductor package in the scan mode, may switch the scan mode to the precision mode, thereby detecting terahertz waves at more detection points than the minimum detection points in the scan mode.

According to the one embodiment, the device further includes an imaging unit, and the imaging unit may scan and image the semiconductor package using the terahertz waves through a reflection mode.

According to the one embodiment, at least one emitter and at least one detector may be provided and the emitter and the detector may be provided to correspond to each other in number.

According to the one embodiment, the terahertz wave may be provided in a pulsed type or in a continuous wave type.

According to the one embodiment, the monitoring unit may monitor a result of a previous process and a state of a current process for the semiconductor package so as to adjust a preset subsequent process condition by tracking a position of the semiconductor chip using the terahertz wave.

Meanwhile, the present invention provides a method for monitoring a semiconductor packaging process using a terahertz wave.

According to the one embodiment, the method for monitoring a semiconductor packaging process using a terahertz wave includes the steps of: generating terahertz waves toward a semiconductor package; detecting terahertz waves reflected from the semiconductor package or terahertz waves transmitting through the semiconductor package; and monitoring a the state of semiconductor package in real time based on the terahertz waves detected in the detecting of the terahertz waves during a packaging process for the semiconductor package, wherein the state of the semiconductor package may include at least one of a misalignment due to two-dimensional translation of a semiconductor chip, a misalignment due to two-dimensional rotation of the semiconductor chip, a deformation due to three-dimensional tilting of the semiconductor chip, and a deformation due to a three-dimensional warpage of the semiconductor package.

According to the one embodiment, the semiconductor package may have at least one detection point set at which the terahertz wave is detected, and the at least one detection point may include at least one border point set on a border of the semiconductor chip, wherein the monitoring may include monitoring the state of the semiconductor package in real time through one monitoring process selected from among a first monitoring process for monitoring in real time a presence of the misalignment due to the two-dimensional translation of the semiconductor chip; a second monitoring process for monitoring in real time a presence of the misalignment due to the two-dimensional rotation of the semiconductor chip; a third monitoring process for monitoring in real time a presence of the deformation due to the three-dimensional tilting of the semiconductor chip; and a fourth monitoring process for monitoring in real time a presence of the deformation due to the three-dimensional warpage of the semiconductor package, wherein when the one monitoring process among the first to fourth monitoring processes is selected, a detection position and a detection number for the at least one detection point may be automatically defined.

### Advantageous Effects

According to the embodiment of the present invention, the device includes: an emitter for generating a terahertz wave toward a semiconductor package; a detector for detecting a terahertz wave generated from the emitter and reflected from the semiconductor package or a terahertz wave transmitted through the semiconductor package; and a monitoring unit for monitoring a state of the semiconductor package in real time based on the terahertz wave detected by the detector during the packaging process for the semiconductor package, wherein the state of the semiconductor package may include at least one of a misalignment due to two-dimensional translation of a semiconductor chip, a misalignment due to two-dimensional rotation of the semiconductor chip, a deformation due to three-dimensional tilting of the semiconductor chip, and a deformation due to a three-dimensional warpage of the semiconductor package.

Accordingly, the device and the method for monitoring a semiconductor packaging process using a terahertz wave may be provided so as to monitor a state of a semiconductor package in real time using a terahertz wave during the semiconductor packaging process.

For example, according to the embodiment of the present invention, the device and the method for monitoring a semiconductor packaging process using a terahertz wave may be provided, and accordingly the resolution can be higher compared to the conventional ultrasound inspections and the inspection speed can be faster compared to the conventional X-ray inspections, so that the inspection can be implemented in real time.

Thus, according to the embodiment of the present invention, a misalignment of a semiconductor chip or a warpage of a semiconductor package can be detected in an early stage in semiconductor packaging processes, such as die attach process, molding process and re-distribution layer process, in which errors occur due to chip movement, so that product defects can be prevented or minimized, and accordingly, process yield and productivity can be improved, and an excessive alignment error can be excluded from subsequent processes in advance to reduce additional process costs.

In other words, according to the embodiment of the present invention, the device and the method for monitoring a semiconductor packaging process using a terahertz wave may be provided, so that the limitations in the conventional non-destructive inspection technology can be overcome.

Further, according to the embodiment of the present invention, the device and the method for monitoring a semiconductor packaging process using a terahertz wave may be provided, so that the human body can be harmless.

### DESCRIPTION OF DRAWINGS

FIG. 1 is a schematic diagram for illustrating a device for monitoring a semiconductor packaging process according to the one embodiment of the present invention.

FIG. 2 is a schematic diagram showing a semiconductor package in a normal state.

FIG. 3 is a schematic diagram showing a semiconductor package in which a semiconductor chip is misaligned.

FIGS. 4 and 5 are schematic diagrams showing semiconductor packages in which warpages occur.

FIG. 6 is a schematic diagram for illustrating a reflection mode of the device for monitoring the semiconductor packaging process according to the one embodiment of the present invention.

FIG. 7 is a schematic diagram for illustrating an orthogonal reflection mode of the device for monitoring the semiconductor packaging process according to the one embodiment of the present invention.

FIG. 8 is a schematic diagram for illustrating an emitter and a detector of the device for monitoring the semiconductor packaging process according to the one embodiment of the present invention.

FIG. 9 is a schematic diagram for illustrating a detection point for detecting terahertz waves in the device for monitoring the semiconductor packaging process according to the one embodiment of the present invention.

FIGS. 10 and 11 are diagrams for illustrating terahertz waves reflected from a semiconductor package.

FIGS. 12 to 14 are diagrams for illustrating a first monitoring mode and a second monitoring mode of a monitoring unit in the device for monitoring the semiconductor packaging process according to the one embodiment of the present invention.

FIGS. 15A to 17 are diagrams for illustrating a third monitoring mode of the monitoring unit in the device for monitoring the semiconductor packaging process according to the one embodiment of the present invention.

FIGS. 18A to 20 are diagrams for illustrating a fourth monitoring mode of the monitoring unit in the device for monitoring the semiconductor packaging process according to the one embodiment of the present invention.

FIG. 21 is a flowchart showing a method for monitoring a semiconductor packaging process according to the one embodiment of the present invention.

FIGS. 22A to 24C are diagrams showing semiconductor package specimens manufactured according to Example 1.

FIGS. 25A and 25B show an image obtained by scanning and imaging the semiconductor package specimens manufactured according to Example 1 using terahertz waves.

FIGS. 26 and 27 are diagrams for illustrating terahertz waves reflected from a semiconductor package specimen manufactured according to Example 1.

FIGS. 28 to 36B are diagrams for illustrating monitoring of normality, misalignment, tilting, and warpage of the semiconductor package specimen manufactured according to Example 1.

FIG. 37 is a schematic diagram showing each detection point of a lookup table.

FIGS. 38A to 38C show schematic diagrams of die shift of semiconductor chips occurring during a molding process in a semiconductor packaging process.

FIG. 39 shows schematic diagrams of alignment errors occurring when semiconductor chips are moved during a semiconductor packaging process such as a die attach process or a rewiring process.

### BEST MODE

### Mode for Invention

Hereinafter, exemplary embodiments of the present invention will be described in detail with reference to the accompanying drawings. However, the technical idea of the present invention is not limited to the exemplary embodiments described herein and may be embodied in other forms. Further, the embodiments are provided to enable contents disclosed herein to be thorough and complete and provided to enable those skilled in the art to fully understand the idea of the present invention.

In the specification, when one component is mentioned as being on another component, it signifies that the one component may be placed directly on another component or a third component may be interposed therebetween. In addition, in the drawings, shapes and sizes may be exaggerated to effectively describe the technical content of the present invention.

In addition, although terms such as first, second and third are used herein to describe various components in various embodiments of the present specification, the components will not be limited by the terms. The above terms are used merely to distinguish one component from another. Accordingly, a first component referred to in one embodiment may be referred to as a second component in another embodiment. Each embodiment described and illustrated herein may also include a complementary embodiment. In addition, the term “and/or” is used herein to include at least one of the components listed before and after the term.

The singular expression herein includes a plural expression unless the context clearly specifies otherwise. In addition, it will be understood that the term such as “include” or “have” herein is intended to designate the presence of feature, number, step, component, or a combination thereof recited in the specification, and does not preclude the possibility of the presence or addition of one or more other features, numbers, steps, components, or combinations thereof. In addition, the term “connection” is used herein to include both indirectly connecting a plurality of components and directly connecting the components.

In addition, in the following description of the embodiments of the present invention, the detailed description of known functions and configurations incorporated herein will be omitted when it possibly makes the subject matter of the present invention unclear unnecessarily.

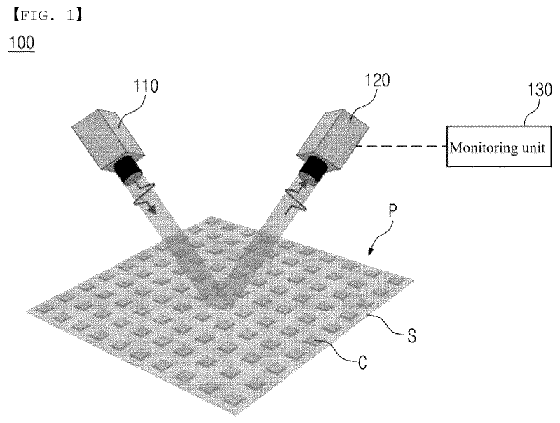

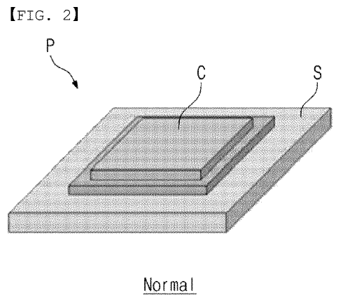

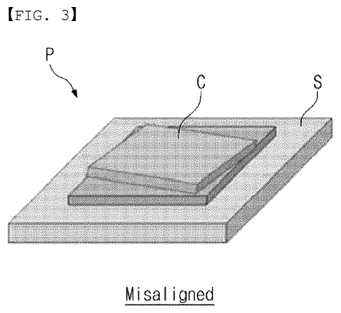

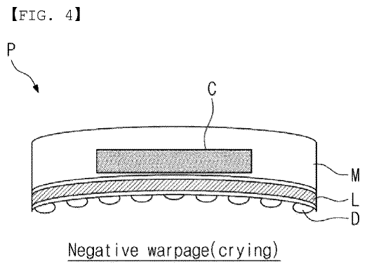

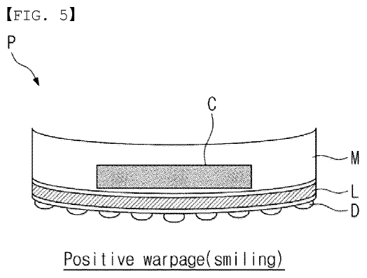

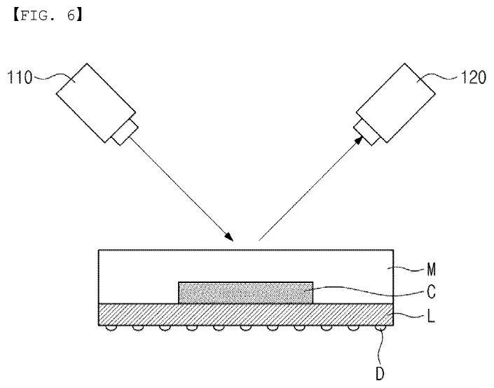

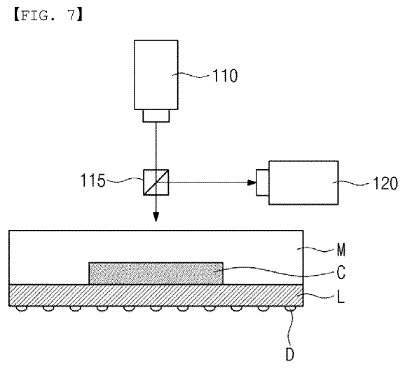

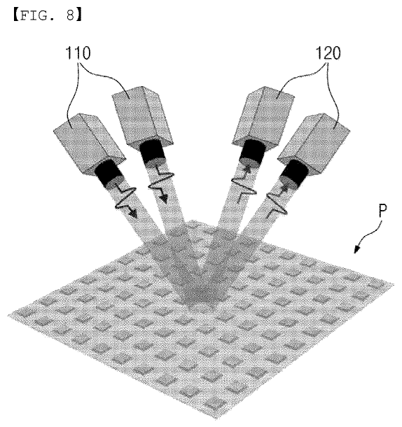

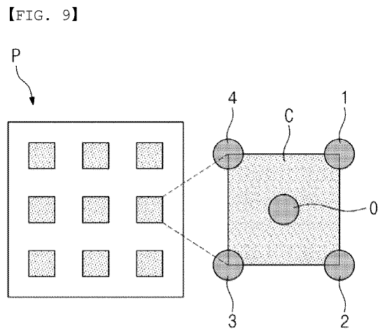

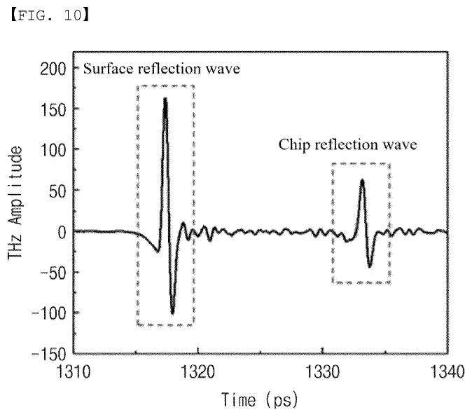

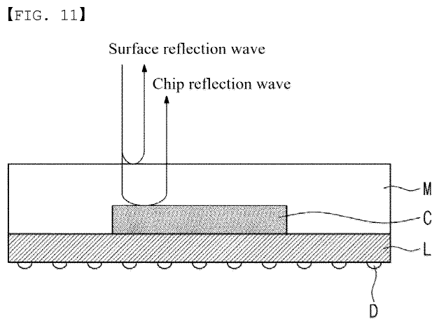

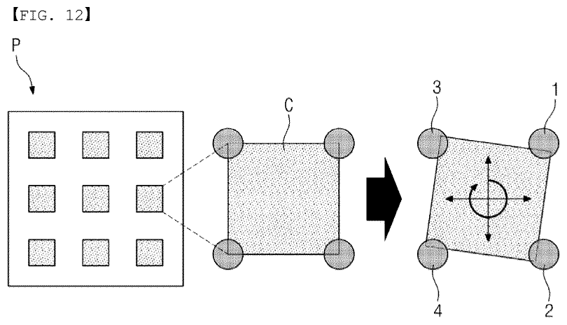

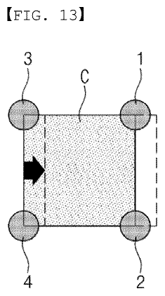

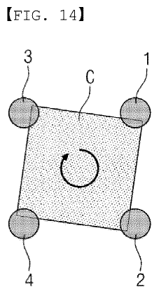

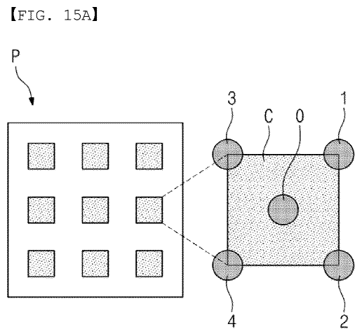

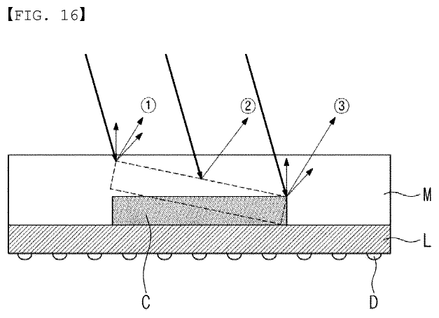

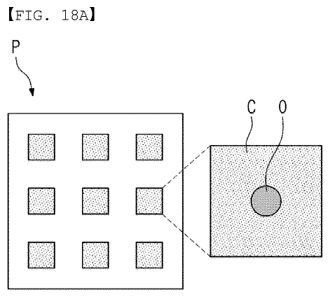

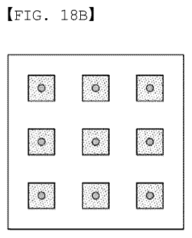

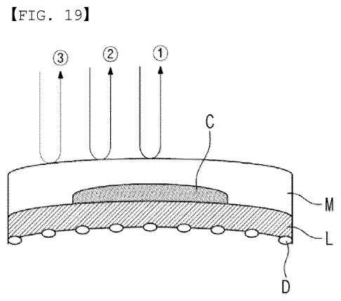

FIG. 1 is a schematic diagram for illustrating a device for monitoring a semiconductor packaging process according to the one embodiment of the present invention; FIG. 2 is a schematic diagram showing a semiconductor package in a normal state; FIG. 3 is a schematic diagram showing a semiconductor package in which a semiconductor chip is misaligned; FIGS. 4 and 5 are schematic diagrams showing semiconductor packages in which warpages occur; FIG. 6 is a schematic diagram for illustrating a reflection mode of the device for monitoring the semiconductor packaging process according to the one embodiment of the present invention; FIG. 7 is a schematic diagram for illustrating an orthogonal reflection mode of the device for monitoring the semiconductor packaging process according to the one embodiment of the present invention; FIG. 8 is a schematic diagram for illustrating an emitter and a detector of the device for monitoring the semiconductor packaging process according to the one embodiment of the present invention; FIG. 9 is a schematic diagram for illustrating a detection point for detecting terahertz waves in the device for monitoring the semiconductor packaging process according to the one embodiment of the present invention; FIGS. 10 and 11 are diagrams for illustrating terahertz waves reflected from a semiconductor package; FIGS. 12 to 14 are diagrams for illustrating a first monitoring mode and a second monitoring mode of a monitoring unit in the device for monitoring the semiconductor packaging process according to the one embodiment of the present invention; FIGS. 15A to 17 are diagrams for illustrating a third monitoring mode of the monitoring unit in the device for monitoring the semiconductor packaging process according to the one embodiment of the present invention; and FIGS. 18A to 20 are diagrams for illustrating a fourth monitoring mode of the monitoring unit in the device for monitoring the semiconductor packaging process according to the one embodiment of the present invention.

As shown in FIG. 1, a semiconductor packaging process monitoring device 100 according to the one embodiment of the present invention refers to a device capable of monitoring a state of a semiconductor package P in real time using terahertz waves during a semiconductor packaging process such as die attach process, molding process, and re-distribution layer (RDL) process.

In other words, as shown in FIG. 2, the semiconductor packaging process monitoring device 100 according to the one embodiment of the present invention may monitor whether the semiconductor package P is in a normal state during the semiconductor packaging process.

In addition, as shown in FIG. 3, the semiconductor packaging process monitoring device 100 according to the one embodiment of the present invention may monitor in real time whether a misalignment occurs in a semiconductor chip C of the semiconductor package P due to translation or rotation during the semiconductor packaging process.

In addition, as shown in FIGS. 4 and 5, the semiconductor packaging process monitoring device 100 according to the one embodiment of the present invention may monitor in real time whether a warpage occurs in the semiconductor package P during the semiconductor packaging process.

According to the one embodiment, the warpage may be monitored in real time for the entire semiconductor package, and monitored in real time for an individual chip therein.

Accordingly, a semiconductor packaging process monitoring device 100 according to the one embodiment of the present invention may detect a fault in the semiconductor package P in an early stage.

Accordingly, defects in the semiconductor package P may be prevented or minimized, thereby improving process yield and productivity.

In addition, when an excessive alignment error occurs in the semiconductor chip C, the semiconductor chip C may be excluded from the subsequent process in advance, and accordingly, additional process costs may be saved.

In other words, the semiconductor packaging process monitoring device 100 according to the one embodiment of the present invention can overcome the limitations in the conventional non-destructive inspection technology.

Further, the semiconductor packaging process monitoring device 100 according to the one embodiment of the present invention has the advantage of being harmless to the human body, unlike the conventional X-ray inspection.

The semiconductor package P monitored through the semiconductor packaging process monitoring device 100 according to the one embodiment of the present invention may include a semiconductor chip C and an epoxy molding compound (EMC) layer M.

The semiconductor chip C may be disposed on a substrate S. In addition, the EMC layer M may be disposed on the substrate S in a form that covers the semiconductor chip C in order to encapsulate the semiconductor chip C.

The substrate S may be removed after the EMC layer M is formed, and a re-distribution layer L and a solder ball D may be sequentially attached on the removed place.

The semiconductor chip C may be electrically connected to a PCB substrate through the re-distribution layer L and the solder ball D.

The semiconductor packaging process monitoring device 100 according to the one embodiment of the present invention may include an emitter 110, a detector 120, and a monitoring unit 130 in order to monitor the semiconductor package P in real time using terahertz waves during the semiconductor packaging process.

The emitter 110 refers to a device that generates terahertz waves toward the semiconductor package P. To this end, the emitter 110 may be disposed to face the semiconductor package P.

The semiconductor package P may be one of a die attach process, a molding process, and a re-distribution layer process in the semiconductor packaging process.

Accordingly, the semiconductor package P may be in a state before forming the EMC layer M, in a state of having formed the EMC layer M, or in a state in which the substrate S is separated and the re-distribution layer L and the solder ball D are attached thereto. In other words, the semiconductor package P defined in the one embodiment of the present invention may be an unfinished semiconductor package P in progress of the packaging process.

According to the one embodiment of the present invention, the terahertz wave generated from the emitter 110 and irradiated toward the semiconductor package P may be provided in a pulsed type or a continuous wave type.

The pulsed type terahertz waves have the advantage of having numerous frequencies so as to be detected at once.

In order to generate the pulsed type terahertz waves, a femtosecond laser functioning as a pump light for generating the pulsed terahertz waves may be irradiated to the emitter 110.

According to the one embodiment of the present invention, the terahertz waves generated from the emitter 110 and irradiated to the semiconductor package P may have a frequency of 0.1 THz to 10 THz.

Meanwhile, according to the one embodiment of the present invention, the emitter 110 and the detector 120 may be configured to operate in a reflection mode based on an optical path of the terahertz waves with respect to the semiconductor package P.

To this end, referring to FIG. 6, the detector 120 may be arranged symmetrically to the emitter 110 based on a normal direction of the semiconductor package P. For example, when the emitter 110 is arranged to be tilted at an angle of 30 degrees from the normal direction of the semiconductor package P, the detector 120 may be arranged to be tilted at an angle of −30 degrees from the normal direction of the semiconductor package P so as to be symmetrical to the emitter.

The terahertz waves generated from the emitter 110, reflected from the semiconductor package P, more specifically, from a surface of the EMC layer M and a surface of the semiconductor chip C, and then detected by the detector 120 are used to calculate parameters for monitoring the state of the semiconductor package P in real time. This will be described below in more detail.

In addition, as shown in FIG. 7, the emitter 110 may be disposed in the normal direction of the semiconductor package P, and a beam splitter 115 may be disposed between the semiconductor package P and the emitter 110. The detector 120 may be disposed parallel to a horizontal direction of the beam splitter 115.

Accordingly, the emitter 110 and the detector 120 may be configured to operate in an orthogonal reflection mode based on the optical path of the terahertz waves with respect to the semiconductor package P through the beam splitter 115.

Although not shown, the semiconductor packaging process monitoring device 100 according to the one embodiment of the present invention may further include an imaging unit.

The imaging unit may scan and image the semiconductor package P by using the terahertz waves through the reflection mode.

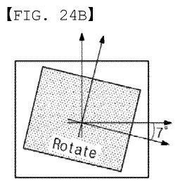

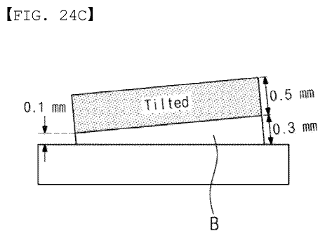

Accordingly, an image (see FIG. 25) about the semiconductor package P generated by the imaging unit may be provided to the monitoring unit 130, and the imaged state of the semiconductor package P may be monitored by an administrator or process monitoring agent that administrates the monitoring unit 130.

Meanwhile, although not shown, the emitter 110 and the detector 120 may be configured to operate in a transmission mode based on the optical path of the terahertz waves with respect to the semiconductor package P.

To this end, the emitter 110 and the detector 120 may be arranged on the same line in the normal direction of the semiconductor package P with the semiconductor package P interposed therebetween.

As shown in FIG. 8, according to the one embodiment of the present invention, one or two or more emitters 110 and detectors 120 may be provided. When two or more emitters 110 and detectors 120 are provided for each, the emitters 110 and the detectors 120 may be provided in corresponding numbers to be paired.

According to the one embodiment of the present invention, the semiconductor package P may have at least one detection point set at which the terahertz waves emitted from the emitter 110 is detected by the detector 120.

The at least one detection point may include at least one border point set on a border of the semiconductor chip C.

As shown in FIG. 9, according to the one embodiment of the present invention, the border points may include a first border point 1, a second border point 2, a third border point 3, and a fourth border point 4 set at four corners of the semiconductor chip C, respectively.

The first border point 1, the second border point 2, the third border point 3, and the fourth border point 4 may be set at positions in which a portion of a section of the terahertz wave detected by the detector 120 overlaps with the semiconductor chip C.

For example, the first border point 1, the second border point 2, the third border point 3, and the fourth border point 4 may be set at positions in which a quarter of the section of the terahertz wave detected by the detector 120 overlaps with the semiconductor chip C.

According to the one embodiment of the present invention, the presence of the misalignment of the semiconductor chip C is determined based on changes in the area in which the portion of the section of the terahertz wave detected by the detector 120 overlaps with the semiconductor chip C. This will be described below in more detail.

In addition, the at least one detection point may further include a center point 0 set at a center of the semiconductor chip C.

When a plurality of emitters 110 and detectors 120 are provided, the emitters 110, for example, may simultaneously irradiate terahertz waves to the first border point 1, the second border point 2, the third border point 3, and the fourth border point 4 set at each of the four corners of the semiconductor chip C and the center point 0 set at the center of the semiconductor chip C.

In addition, the detectors 120 may simultaneously detect terahertz waves reflected from the above detection points.

Although not shown, the semiconductor packaging process monitoring device 100 according to the one embodiment of the present invention may further include a focus precision adjustment unit.

The focus precision adjustment unit may be provided in each of the emitter 110 and the detector 120. The focus precision control unit may precisely move focuses of the terahertz waves by targeting the corresponding detection points matching with the corresponding emitter 110 and the corresponding detector 120.

The monitoring unit 130 may monitor the state of the semiconductor package P in real time based on the terahertz waves detected by the detector 120 during the packaging process for the semiconductor package P.

According to the one embodiment of the present invention, the state of the semiconductor package P may include at least one of a misalignment due to two-dimensional translation of the semiconductor chip C, a misalignment due to two-dimensional rotation of the semiconductor chip C, a deformation due to three-dimensional tilting of the semiconductor chip C, and a deformation due to a three-dimensional warpage of the semiconductor package P.

According to the one embodiment of the present invention, the monitoring unit 130 may monitor the state of the semiconductor package P in real time through any one monitoring mode selected from the first monitoring mode, the second monitoring mode, the third monitoring mode and the fourth monitoring mode.

The first monitoring mode, the second monitoring mode, the third monitoring mode and the fourth monitoring mode may be selected by the administrator or monitoring agent.

When any one of the first monitoring mode, the second monitoring mode, the third monitoring mode and the fourth monitoring mode is selected, a detection position and a detection number for the detection point may be automatically defined.

For example, when the first monitoring mode is selected, the number of detection points may be automatically set among the center point 0, the first border point 1, the second border point 2, the third border point 3, and the fourth border point 4 to detect the terahertz waves reflected therefrom, and once the number of detection points is set, it may be automatically set which detection points are used to detect the terahertz waves reflected therefrom.

According to the one embodiment of the present invention, when the first monitoring mode is selected, the monitoring unit 130 may monitor in real time a presence of the misalignment due to the two-dimensional translation of the semiconductor chip C.

The first monitoring mode is configured to determine a presence of the misalignment due to the two-dimensional translation of the semiconductor chip C through an increase or decrease in reflectance of the terahertz wave detected from the at least one detection point set as the detection position

Referring to FIGS. 10 and 11, the terahertz waves irradiated onto the semiconductor package P may be detected as reflection waves reflected from the surface of the semiconductor package P, more specifically, reflection waves reflected from the surface of the EMC layer M and reflected waves reflected from the surface of the semiconductor chip C.

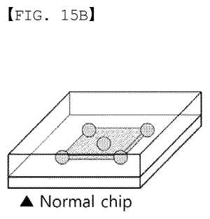

Referring to FIGS. 12 and 13, when the first monitoring mode is selected, the monitoring unit 130 may monitor a presence of the misalignment due to the two-dimensional translation of the semiconductor chip C through the increase or decrease in reflectance of the terahertz waves detected from the first border point 1, the second border point 2, the third border point 3, and the fourth border point 4.

When the two-dimensional translation of the semiconductor chip C occurs during the semiconductor packaging process, the area of a portion of a section of the terahertz wave overlapping with the semiconductor chip C at each of the first boundary point 1, the second boundary point 2, the third boundary point 3 and the fourth boundary point 4 may be changed in a direction of the two-dimensional translation of the semiconductor chip C compared to the overlap area in the normal state, and the reflectance and the amplitude of the terahertz wave may be changed by the changes in the overlap area.

The monitoring unit 130 may monitor the presence of the misalignment due to the two-dimensional translation of the semiconductor chip C by calculating the reflectance of the changed terahertz wave.

The reflectance may be calculated, as in Equation 1 below, by the ratio of amplitude (E_{Ry}) of the terahertz wave reflected from the center point 0 in the normal state and amplitude E_{Rs}) of the terahertz wave reflected from one of the first border point 1, the second border point 2, the third border point 3, and the fourth border point 4 during the packaging process.

$$Reflectance = \frac{{E}_{Rs}}{{E}_{Rr}} \qquad [ Equation 1 ]$$

The detection position in which the amplitude and the reflectance of the terahertz wave increase is the direction in which the semiconductor chip C has translated, and a degree of the two-dimensional translation of the semiconductor chip C may be calculated through the increase and decrease in reflectance of terahertz waves detected from at least three border points.

Meanwhile, in the case of the transmission mode, the transmittance may be calculated, as in Equation 2 below, by the ratio of amplitude (E_{Ts}) of the terahertz wave transmitted from the center point 0 in the normal state and amplitude (E_{Ts}) of the terahertz wave transmitted from one of the first border point 1, the second border point 2, the third border point 3, and the fourth border point 4 during the packaging process.

$$Transmittance = \frac{{E}_{T s}}{{E}_{T r}} \qquad [ Equation 2 ]$$

Accordingly, when the misalignment due to the two-dimensional translation of the semiconductor chip C is confirmed and the degree of the two-dimensional translation of the semiconductor chip C is calculated through the first monitoring mode, a subsequent process condition may be adjusted to correspond to the misalignment due to the two-dimensional translation of the semiconductor chip C.

For example, when the misalignment due to the two-dimensional translation of the semiconductor chip C is confirmed and the degree of the two-dimensional translation of the semiconductor chip C is calculated through the first monitoring mode, a position of a wire having a fixed position may be modified during the re-distribution layer process.

In addition, the process condition such as a die attach process, a flip chip process, and a molding process may be adjusted to correspond to the misalignment due to the two-dimensional translation of the semiconductor chip C.

Accordingly, the semiconductor package P can be manufactured even when the misalignment due to the two-dimensional translation of the semiconductor chip C occurs, so that process yield can be improved.

In addition, referring back to FIG. 12, when the second monitoring mode is selected, the monitoring unit 130 may monitor in real time the presence of the misalignment due to the two-dimensional rotation of the semiconductor chip C.

The second monitoring mode is configured to determine the presence of the misalignment due to the two-dimensional rotation of the semiconductor chip C through an increase or decrease in reflectance of the terahertz wave detected from the at least one detection point set as the detection position.

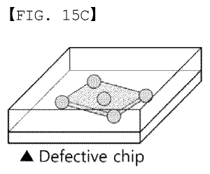

Referring to FIG. 14, when the second monitoring mode is selected, the monitoring unit 130 may monitor the presence of the misalignment due to the two-dimensional rotation of the semiconductor chip C through the increase or decrease in reflectance of the terahertz waves detected from the first border point 1, the second border point 2, the third border point 3, and the fourth border point 4.

When the two-dimensional rotation of the semiconductor chip C occurs during the semiconductor packaging process, the area of a portion of a section of the terahertz wave overlapping with the semiconductor chip C at each of the first boundary point 1, the second boundary point 2, the third boundary point 3 and the fourth boundary point 4 may be changed in a direction of the two-dimensional rotation of the semiconductor chip C compared to the overlap area in the normal state, and the reflectance of the terahertz wave may be changed by the changes in the overlap area.

The monitoring unit 130 may monitor the presence of the misalignment due to the two-dimensional rotation of the semiconductor chip C, by calculating the reflectance of the changed terahertz wave through Equation 1.

The detection position in which the amplitude and the reflectance of the terahertz wave increase is the direction in which the semiconductor chip C has two-dimensionally rotated, and a degree of the two-dimensional rotation of the semiconductor chip C may be calculated through the increase and decrease in reflectance of terahertz waves detected from at least two border points.

Referring to FIGS. 15A to 15C, when the third monitoring mode is selected, the monitoring unit 130 may monitor in real time a presence of the deformation due to the three-dimensional tilting of the semiconductor chip C.

The third monitoring mode is configured to calculate a degree of the deformation due to the three-dimensional tilting of the semiconductor chip C through a detection time difference of the terahertz waves detected from the at least one detection point set as the detection position.

In other words, when the third monitoring mode is selected, the monitoring unit 130 may monitor the degree of the deformation due to the three-dimensional tilting of the semiconductor chip C through the detection time difference of the terahertz waves detected from the center point 0, the first border point 1, the second border point 2, the third border point 3, and the fourth border point 4.

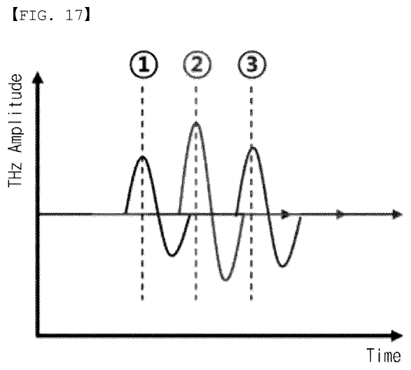

Referring to FIGS. 16 and 17, when the three-dimensional tilting occurs in the semiconductor chip C, reflection angles of the terahertz waves reflected at each detection point may be changed. Scattering may occur at the border point, and accordingly the amplitude of the reflected terahertz wave may be decreased, and a difference in detection time for each detection position of the reflected terahertz wave may occur due to the tilting.

The monitoring unit 130 may calculate the degree of the tilting of the semiconductor chip C by using the difference in detection time for each detection position. To this end, at least two detection points may be set in the third monitoring mode.

The degree of the tilting of the semiconductor chip C may be calculated, as in Equation 3 below, by deriving the position of the semiconductor chip C for each detection position by converting the terahertz wave detection time into an optical path inside the semiconductor package P.

$$d = \frac{c \cdot cos θ}{2 n} Δ t \qquad [ Equation 3 ]$$

Herein, c is a speed of light, n is a refractive index, and Δt is a detection time difference.

In addition, referring to FIGS. 18A and 18B, when the fourth monitoring mode is selected, the monitoring unit 130 may monitor in real time a presence of the deformation due to the three-dimensional warpage of the semiconductor package P.

The fourth monitoring mode is configured to calculate a degree of the deformation due to the three-dimensional warpage of the semiconductor package P through the detection time difference of the terahertz waves detected from the at least one detection point set as the detection position.

In other words, when the fourth monitoring mode is selected, the monitoring unit 130 may monitor the degree of the deformation due to the three-dimensional warpage of the semiconductor package P through the detection time difference of the terahertz waves detected from the center point 0, the first border point 1, the second border point 2, the third border point 3, and the fourth border point 4.

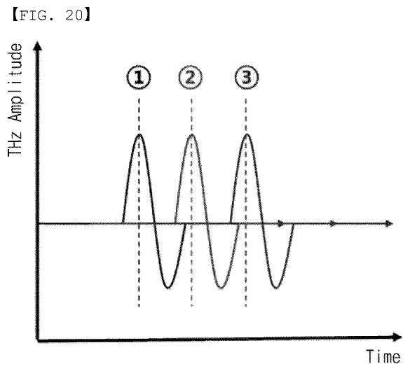

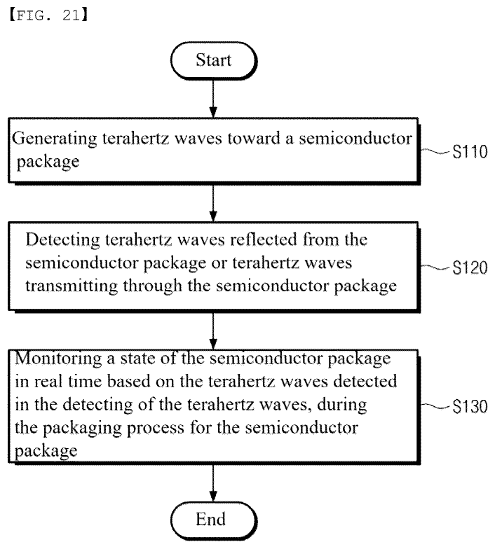

Referring to FIGS. 19 and 20, when the warpage occurs in the semiconductor package P during the semiconductor packaging process, a difference between surface heights created by the warpage may cause a time delay in the detection time for each detection position of the terahertz waves.

The monitoring unit 130 may monitor the degree of the warpage of the semiconductor package P through the time delay in the detection time for each detection position of the terahertz waves.

Meanwhile, according to the one embodiment of the present invention, the monitoring unit 130 may monitor the state of the semiconductor package P through a scan mode and a precision mode.

First, the monitoring unit 130 through the above scan mode, may detect terahertz waves at minimum detection points among at least one detection point set in the semiconductor package P, and accordingly, quickly check an occurrence of abnormality in the semiconductor package P.

When the abnormality is detected in a state of the semiconductor package P during the scan mode, the monitoring unit 130 may switch the scan mode to the precision mode so as to detect terahertz waves at more detection points than the minimum detection points in the scan mode, so that the abnormality in the semiconductor package P may be precisely monitored.

Accordingly, the monitoring may be precisely performed only when the abnormality is checked, so that a load on a system can be reduced.

According to the one embodiment of the present invention, the monitoring unit 130 may track a position of the semiconductor chip C by using the terahertz waves.

The monitoring unit 130 may monitor a result of the previous process and a state of the current process for the semiconductor package P by tracking the position of the semiconductor chips C.

Accordingly, a preset subsequent process condition may be adjusted based on the position of the tracked semiconductor chip C.

For example, when terahertz waves are not detected at the set detection points during tracking the position of the semiconductor chip C, the monitoring unit 130 may determine that the semiconductor chip C deviates from the process positions.

When determining that the semiconductor chip C has deviated from of the process positions, the monitoring unit 130 may check the position of the semiconductor chip C by scanning the entire area of the semiconductor package P using terahertz waves.

Accordingly, the subsequent process condition may be adjusted, and when it is determined as defective, a packaging for the semiconductor chip C may be excluded in the subsequent process.

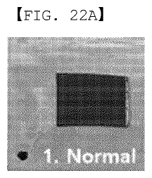

Hereinafter, the method for monitoring a semiconductor packaging process using a terahertz wave according to the one embodiment of the present invention will be described with reference to FIG. 21.

FIG. 21 is a flowchart showing the method for monitoring a semiconductor packaging process using terahertz waves according to the one embodiment of the present invention.

Referring to FIG. 21, the method for monitoring a semiconductor packaging process using a terahertz wave according to the one embodiment of the present invention may include step S110, step S120 and step S130.

### Step S110

Step S110 is a step of generating terahertz waves toward the semiconductor package P.

In step S110, terahertz waves may be generated toward the semiconductor package P through a reflection mode.

To this end, in step S110, the terahertz waves may be generated so that the terahertz waves are incident onto the semiconductor package P at an angle exceeding 0° and less than 90°.

In addition, in step S110, terahertz waves may also be generated toward the semiconductor package P through a transmission mode.

Meanwhile, according to the one embodiment of the present invention, In step S110, the focus of the generated terahertz waves may be adjusted so that the terahertz waves are precisely irradiated to at least one detection point set in the semiconductor package P.

The detection point may include a center point 0 set at a center of the semiconductor chip C, and four border points 1, 2, 3, 4 set at borders of the semiconductor chip C, for example, at four corners of the semiconductor chip C, respectively.

### Step S120

Step S120 is a step of detecting the terahertz waves generated toward the semiconductor package P and passing the semiconductor package P.

In step S120, and when the terahertz waves are generated toward the semiconductor package P through the reflection mode in step S110, terahertz waves reflected from a surface of an EMC layer M of the semiconductor package P and a surface of the semiconductor chip C may be detected.

In addition, in step S120, and when the terahertz waves are generated toward the semiconductor package P through the transmission mode in step S110, the terahertz waves passing through the semiconductor package P may be detected.

### Step S130

Step S130 is a step of monitoring a state of the semiconductor package P in real time based on the terahertz waves detected in the step S120 during the packaging process for the semiconductor package P.

According to the one embodiment of the present invention, the state of the semiconductor package P may include at least one of a misalignment due to two-dimensional translation of the semiconductor chip C, a misalignment due to two-dimensional rotation of the semiconductor chip C, a deformation due to three-dimensional tilting of the semiconductor chip C, and a deformation due to a three-dimensional warpage of the semiconductor package P.

According to the one embodiment of the present invention, in step S130, the state of the semiconductor package P may be monitored in real time through any one monitoring process selected from the first monitoring process, the second monitoring process, the third monitoring process and the fourth monitoring process.

When any one of the first monitoring process, the second monitoring process, the third monitoring process and the fourth monitoring process is selected, a detection position and a detection number for the detection point may be automatically defined.

In step S130, when the first monitoring process is selected, a presence of the misalignment due to the two-dimensional translation of the semiconductor chip C may be monitored in real time.

In step S130, a presence of the misalignment due to the two-dimensional translation of the semiconductor chip C may be monitored through an increase or decrease in reflectance of the terahertz wave detected from the at least one detection point set as the detection position.

in step S130, a presence of the misalignment due to the two-dimensional translation of the semiconductor chip C may be monitored by calculating the changed reflectance at the detection point based on the reflectance in a normal state.

In addition, in step S130, when the second monitoring process is selected, a presence of the misalignment due to the two-dimensional rotation of the semiconductor chip C may be monitored in real time.

In step S130, a presence of the misalignment due to the two-dimensional rotation of the semiconductor chip C may be monitored through an increase or decrease in reflectance of the terahertz wave detected from the at least one detection point set as the detection position.

In addition, in step S130, when the third monitoring process is selected, a presence of the deformation due to the three-dimensional tilting of the semiconductor chip C may be monitored in real time.

In step S130, a degree of the deformation due to the three-dimensional tilting of the semiconductor chip C may be calculated through a detection time difference of the terahertz waves detected from the at least one detection point set as the detection position.

To this end, in step S130, when the third monitoring process is selected, at least two detection points may be set.

Further, in step S130, when the fourth monitoring process is selected, a presence of the deformation due to the three-dimensional warpage of the semiconductor package P may be monitored in real time.

In step S130, a degree of the deformation due to the three-dimensional warpage of the semiconductor package P may be calculated through a detection time difference of the terahertz waves detected from the at least one detection point set as the detection position.

In other words, in step S130, when the fourth monitoring process is selected, a degree of the warpage of the semiconductor package P may be monitored through the delay in detection time for each detection position of terahertz waves.

Meanwhile, in step S130, terahertz waves may be detected at minimum detection points among at least one detection point set in the semiconductor package P, and accordingly, an occurrence of abnormality in the semiconductor package P may be quickly checked.

In step S130, when the abnormality is detected in a state of the semiconductor package P, terahertz waves may be detected at more detection points than the minimum detection points, so that the abnormality in the semiconductor package P may be precisely monitored.

According to the one embodiment of the present invention, in step S130, when terahertz waves are not detected at the set detection points, it may be determined that the semiconductor chip C deviates from the process positions.

In step S130, when it is determined that the semiconductor chip C deviates from the process positions. a position of the semiconductor chip C may be checked by scanning the entire area of the semiconductor package P using terahertz waves.

Thus, the subsequent process condition may be adjusted, and when it is determined as defective, a packaging for the semiconductor chip C may be excluded in the subsequent process.

### Example 1

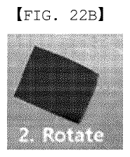

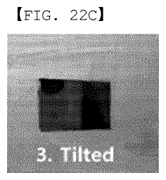

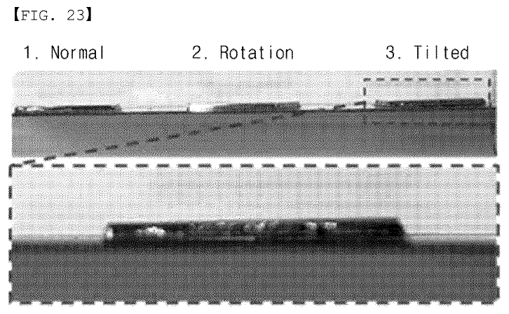

As shown in FIGS. 22A to 22C and 23, a semiconductor package specimen is produced by attaching silicon chips onto a copper plate and performing EMC molding.

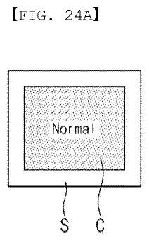

As shown in FIGS. 24A to 24C, the silicon chips C are attached to the copper plate S so as to be in a normal state, a 7°-rotated state, and a tilted state. The tilted state is obtained by using a bonder that is left-right asymmetric (based on the drawing) to apply a tilt to the silicon chip C.

Thereafter, as shown in FIGS. 25A and 25B, the copper plate S having the attached silicon chips C is molded with hot press to produce a semiconductor package specimen, and then scanned and imaged through the terahertz reflection mode.

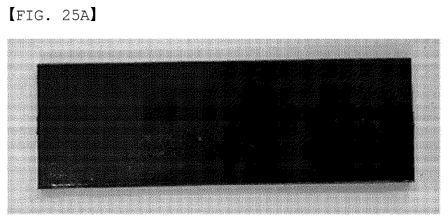

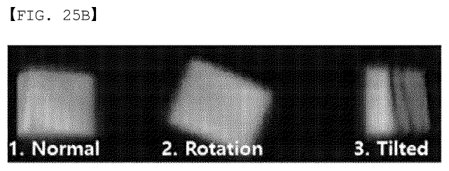

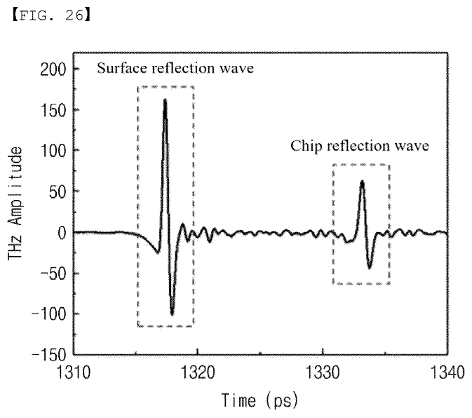

Referring to FIGS. 26 and 27, terahertz waves irradiated on the semiconductor package specimen are detected after being reflected from the surface of the EMC layer M and the surface of the silicon chip C.

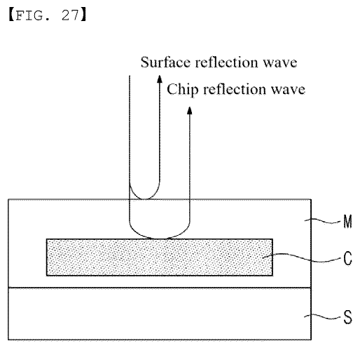

Referring to FIG. 28, when the silicon chip C is in the normal state, it is confirmed that the terahertz waves reflected from border points Normal #1, Normal #2, Normal #3 and Normal #4 as detection points set at four corners of the silicon chip C, respectively, are detected as having the amplitude of approximately 25% of the terahertz wave reflected from a center point Center set at a center of the silicon chip C.

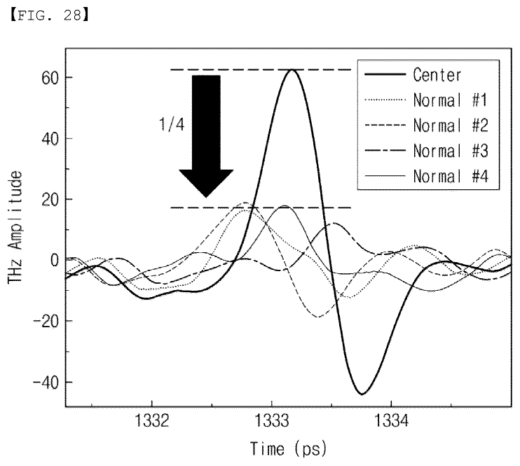

Referring to FIG. 29, this is because the area of the silicon chip C overlapping with a section of the terahertz wave at the border point is ¼ of the section of the terahertz wave, when the silicon chip C is in the normal state.

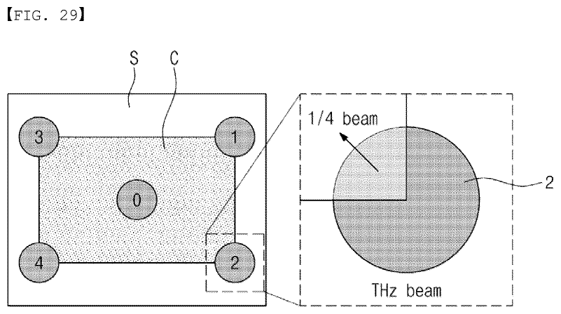

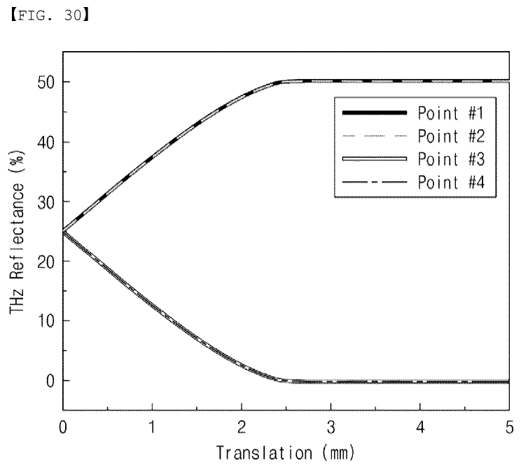

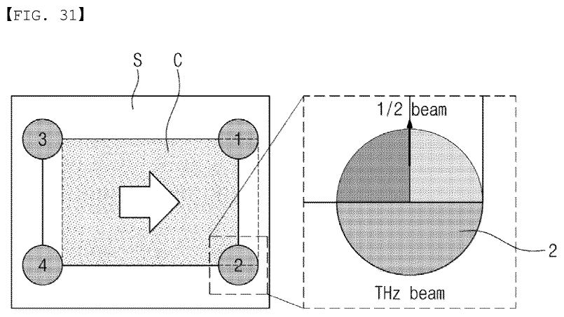

As shown in FIG. 30, when the silicon chip C moves to the right (based on FIG. 31), the reflectance of the terahertz wave is theoretically derived as follows: the reflectance of terahertz waves reflected from the border points Point #1 and Point #2 in the moving direction of the silicon chip C is increased, and the reflectance of terahertz waves reflected from the border points Point #3 and Point #4 in the opposite direction is decreased.

Referring to FIG. 31, this is because, at the border points Point #1 and Point #2 in the moving direction of the silicon chip C, the area of the silicon chip C overlapping with the section of the terahertz wave is increased from ¼ of the normal state to ½.

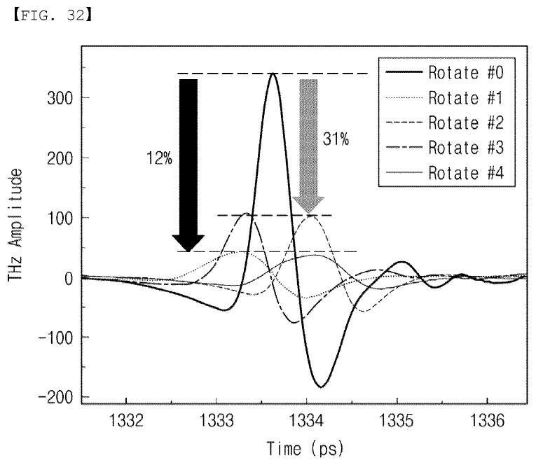

Referring to FIG. 32, it is confirmed that when the silicon chip C is two-dimensionally rotated, amplitudes of the terahertz wave reflected from the center point Rotate #0 and the terahertz waves reflected from the border points Rotate #1, Rotate #2, Rotate #3 and Rotate #4 are measured to be different from the amplitudes in the normal state.

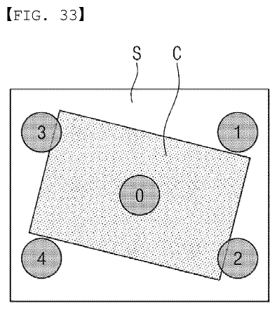

Referring to FIG. 33, the terahertz waves reflected from the 2nd and 3rd border points in the rotational direction of the silicon chip C are detected as having amplitudes higher than the terahertz waves reflected in the normal state, and the terahertz waves reflected from the 1st and 4th border points in the opposite rotational direction are detected as having amplitudes lower than in the normal state.

This is because the area of the silicon chip C overlapping with the section of the terahertz wave is increased for the border points positioned in the rotational direction and decreased for the border points positioned in the opposite rotational direction.

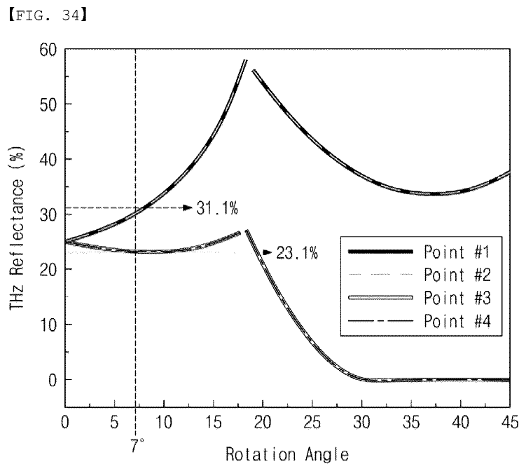

Referring to FIG. 34, it is confirmed that the graph shows the same trend of the simulation assuming that the terahertz wave reflectance of the silicon chip C is 100%.

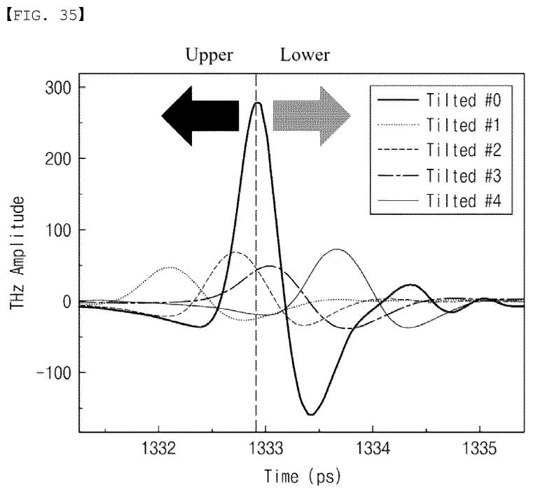

Referring to FIG. 35, in the case of a semiconductor package specimen in which the silicon chip C is in a three-dimensionally tilted state, the terahertz waves reflected from the center point and the border points have different detection times according to the detection positions.

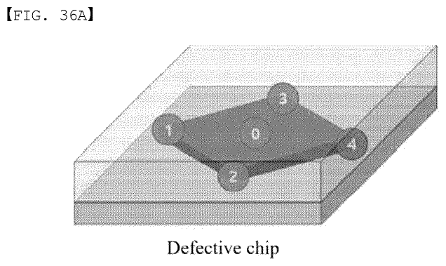

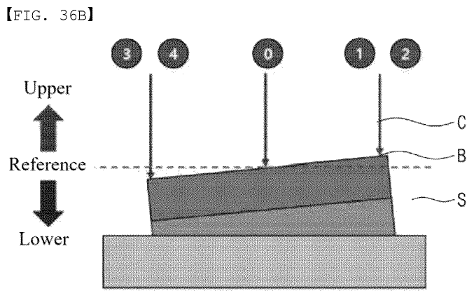

Referring to FIGS. 36A and 36B, the terahertz waves reflected from the 3rd and 4th border points set in the tilted lower direction are detected later than the terahertz wave reflected from the center point #0 because optical paths inside the EMC layer are longer, and the terahertz waves reflected from the 1st and 2nd border points positioned higher than the center point #0 are detected earlier than the terahertz wave reflected from the center point #0 because optical paths inside the EMC layer are shorter.

Thus, it is confirmed that the three-dimensional alignment state of the silicon chip C can be monitored through the differences in detection time of the terahertz wave detected at each detection position.

Table 1 below shows a lookup table for monitoring the semiconductor packaging process through the increase or decrease in the amplitude of terahertz waves reflected from the detection points set in the semiconductor package.

TABLE 1

| | 1st | 2nd | 3rd | 4th | 5th | |
|---|---|---|---|---|---|---|
| Number | THz | THz | THz | THz | THz | Determination |
| 1 | ↑ | ↑ | ↑ | ↑ | — | Stage focus issue |
| 2 | ↑ | ↑ | ↓ | ↓ | — | Chip moves leftward |
| 3 | ↑ | ↓ | ↓ | ↑ | — | Chip moves downward |
| 4 | ↓ | ↓ | ↑ | ↑ | — | Chip moves rightward |
| 5 | ↑ | ↓ | ↑ | ↓ | — | Chip rotates |
| | | | | | | counterclockwise |
| 6 | ↓ | ↑ | ↑ | ↓ | — | Chip moves upward |
| 7 | ↓ | ↑ | ↓ | ↑ | — | Chip rotates clockwise |
| 8 | ↑ | ↓ | ↓ | ↓ | — | Chip moves leftward and |
| | | | | | | downward |
| 9 | ↓ | ↓ | ↓ | ↑ | — | Chip moves rightward and |
| | | | | | | downward |
| 10 | ↓ | ↓ | ↑ | ↓ | — | Chip moves rightward and |
| | | | | | | upward |
| 11 | ↓ | ↑ | ↓ | ↓ | — | Chip moves leftward and |
| | | | | | | upward |
| 12 | ↓ | ↓ | ↓ | ↓ | ↓ | Chip tilting occurs |

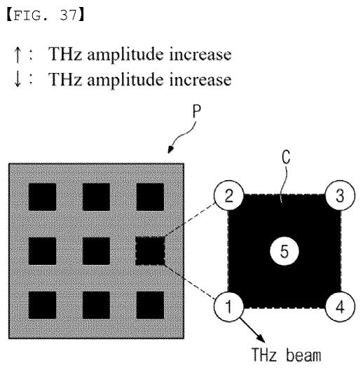

Referring to Table 1 and FIG. 37 showing each detection point of the lookup table, the lookup table is produced to serve as a manual capable of monitoring the state of the semiconductor package through the increase or decrease in amplitude of the terahertz waves according to detection positions of the terahertz waves.

First, when case 1 is monitored, in which all of amplitudes of terahertz waves reflected from the first to fourth border points are increased, it may be determined to be a stage focus issue.

Next, when case 2 is monitored, in which amplitudes of the terahertz waves reflected from the first and second border points are increased and amplitudes of the terahertz waves reflected from the third and fourth border points are decreased, it may be determined that the chip has moved leftward based on the drawing.

Next, when case 3 is monitored, in which amplitudes of the terahertz waves reflected from the first and fourth border points are increased and amplitudes of the terahertz waves reflected from the second and third border points are decreased, it may be determined that the chip has moved downward based on the drawing.

Next, when case 4 is monitored, in which amplitudes of the terahertz waves reflected from the third and fourth border points are increased and amplitudes of the terahertz waves reflected from the first and second border points are decreased, it may be determined that the chip has moved rightward based on the drawing.

Next, when case 5 is monitored, in which amplitudes of the terahertz waves reflected from the first and third border points are increased and amplitudes of the terahertz waves reflected from the second and fourth border points are decreased, it may be determined that the chip has rotated counterclockwise based on the drawing.

Next, when case 6 is monitored, in which amplitudes of the terahertz waves reflected from the second and third border points are increased and amplitudes of the terahertz waves reflected from the first and fourth border points are decreased, it may be determined that the chip has moved upward based on the drawing.

Next, when case 7 is monitored, in which amplitudes of the terahertz waves reflected from the second and fourth border points are increased and amplitudes of the terahertz waves reflected from the first and third border points are decreased, it may be determined that the chip has rotated clockwise based on the drawing.

Next, when case 8 is monitored, in which an amplitude of the terahertz wave reflected from the first border point is increased and amplitudes of the terahertz waves reflected from the second, third and fourth border points are decreased, it may be determined that the chip has moved leftward and downward based on the drawing.

Next, when case 9 is monitored, in which an amplitude of the terahertz wave reflected from the fourth border point is increased and amplitudes of the terahertz waves reflected from the first, second and third border points are decreased, it may be determined that the chip has moved rightward and downward based on the drawing.

Next, when case 10 is monitored, in which an amplitude of the terahertz wave reflected from the third border point is increased and amplitudes of the terahertz waves reflected from the first, second and fourth border points are decreased, it may be determined that the chip has moved rightward and upward based on the drawing.

Next, when case 11 is monitored, in which an amplitude of the terahertz wave reflected from the second border point is increased and amplitudes of the terahertz waves reflected from the first, third and fourth border points are decreased, it may be determined that the chip has moved leftward and upward based on the drawing.

Finally, when case 12 is monitored, in which all of amplitudes of terahertz waves reflected from the first to fourth border points and the fifth center point are decreased, it may be determined that the chip is three-dimensionally tilted.

However, this is merely the example, and the detection positions and the number of terahertz waves may vary depending on monitoring schemes and packaging conditions.

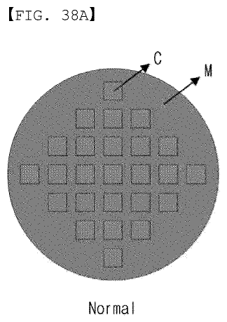

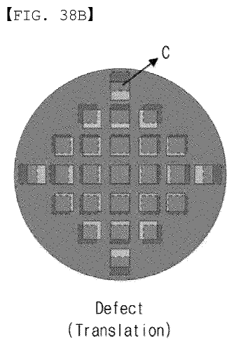

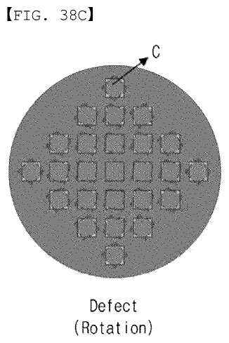

As shown in FIGS. 38A to 38C, the device and the method for monitoring a semiconductor packaging process according to the one embodiment of the present invention can inspect the die shift caused by movements of the EMC under high temperature and high pressure conditions during the semiconductor molding process.

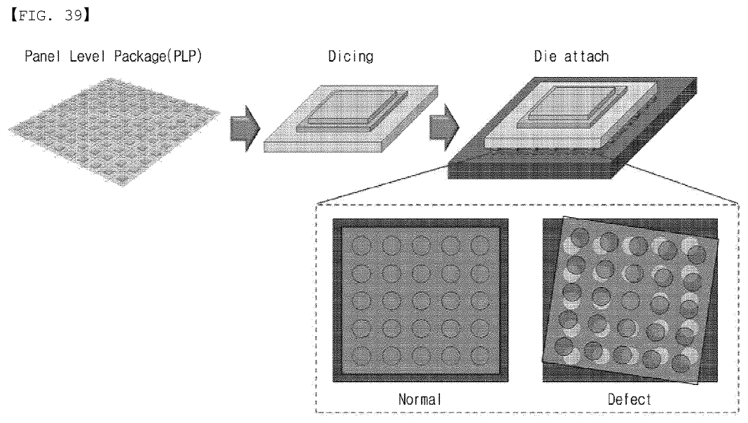

In addition, as shown in FIG. 39, the device and the method for monitoring a semiconductor packaging process according to the one embodiment of the present invention can inspect in advance the alignment errors that occur when chips are moved to subsequent process position, such as die attach process and re-distribution (RDL) process.

Thus, the device and the method for monitoring a semiconductor packaging process according to the one embodiment of the present invention can detect the alignment errors of semiconductor chips occurring in the semiconductor packaging process at an early stage, and accordingly, the position and alignment state of the semiconductor chips can be reflected in the subsequent process, so that process yield and productivity can be improved.

In addition, when excessive alignment errors of the semiconductor chips are monitored through the device and method for monitoring a semiconductor packaging process according to the one embodiment of the present invention, a packaging of the corresponding semiconductor chip can be excluded in the subsequent process, so that process costs can be saved.

Although the present invention has been described in detail with reference to the preferred embodiments, the present invention is not limited to the specific embodiments and will be interpreted by the following claims. In addition, it will be apparent that a person having ordinary skill in the art may carry out various deformations and modifications for the embodiments described as above within the scope without departing from the present invention.

1. A device for monitoring a semiconductor packaging process using a terahertz wave, the device comprising:
an emitter for generating a terahertz wave toward a semiconductor package;
a detector for detecting a terahertz wave generated from the emitter and reflected from the semiconductor package or a terahertz wave transmitted through the semiconductor package; and
a monitoring unit for monitoring a state of the semiconductor package in real time based on the terahertz wave detected by the detector during the packaging process for the semiconductor package, wherein
the state of the semiconductor package includes at least one of a misalignment due to two-dimensional translation of a semiconductor chip, a misalignment due to two-dimensional rotation of the semiconductor chip, a deformation due to three-dimensional tilting of the semiconductor chip, and a deformation due to a three-dimensional warpage of the semiconductor package.

2. The device of claim 1, wherein the semiconductor package has at least one detection point set at which the terahertz wave emitted from the emitter is detected by the detector, and
the at least one detection point includes at least one border point set on a border of the semiconductor chip.

3. The device of claim 2, wherein the monitoring unit monitors the state of the semiconductor package in real time through one monitoring mode selected from among:
a first monitoring mode for monitoring in real time a presence of the misalignment due to the two-dimensional translation of the semiconductor chip;
a second monitoring mode for monitoring in real time a presence of the misalignment due to the two-dimensional rotation of the semiconductor chip;
a third monitoring mode for monitoring in real time a presence of the deformation due to the three-dimensional tilting of the semiconductor chip; and
a fourth monitoring mode for monitoring in real time a presence of the deformation due to the three-dimensional warpage of the semiconductor package, wherein
when the one monitoring mode among the first to fourth monitoring modes is selected, a detection position and a detection number for the at least one detection point are automatically defined.

4. The device of claim 3, wherein the border point is set at a position in which a portion of a section of the terahertz wave detected by the detector overlaps with the semiconductor chip.

5. The device of claim 4, wherein the first monitoring mode is configured to determine the presence of the misalignment due to the two-dimensional translation of the semiconductor chip through an increase or decrease in reflectance of the terahertz wave detected from the at least one detection point defined as the detection position, such that a degree of the two-dimensional translation of the semiconductor chip is calculated through an increase or decrease in reflectance of a terahertz wave detected in each of at least three border points, and
the second monitoring mode is configured to determine the presence of the misalignment due to the two-dimensional rotation of the semiconductor chip through the increase or decrease in reflectance of the terahertz wave detected from the at least one detection point defined as the detection position, such that a degree of the two-dimensional rotation of the semiconductor chip is calculated through an increase or decrease in reflectance of a terahertz wave detected in each of at least two border points.

6. The device of claim 5, wherein when the misalignment due to the two-dimensional translation of the semiconductor chip is confirmed and the degree of the two-dimensional translation of the semiconductor chip is calculated through the first monitoring mode, a subsequent process condition is adjusted to correspond to the misalignment due to the two-dimensional translation of the semiconductor chip.

7. The device of claim 4, wherein the third monitoring mode is configured to calculate a degree of the deformation due to the three-dimensional tilting of the semiconductor chip through a detection time difference of terahertz waves detected in the at least one detection point defined as the detection position, and
the fourth monitoring mode is configured to calculate a degree of the deformation due to the three-dimensional warpage of the semiconductor package through the detection time difference of the terahertz waves detected in the at least one detection point defined as the detection position.

8. The device of claim 2, wherein the monitoring unit monitors the state of the semiconductor package through a scan mode and a precision mode,
the scan mode is configured to detect terahertz waves at minimum detection points among the at least one detection point, and
the monitoring unit, when detecting an abnormality in the state of the semiconductor package in the scan mode, switches the scan mode to the precision mode, thereby detecting terahertz waves at more detection points than the minimum detection points in the scan mode.

9. The device of claim 1, further comprising:
an imaging unit for scanning and imaging the semiconductor package using the terahertz waves through a reflection mode.

10. The device of claim 1, wherein at least one emitter and at least one detector are provided and the emitter and the detector are provided to correspond to each other in number.

11. The device of claim 1, wherein the terahertz wave is provided in a pulsed type or in a continuous wave type.

12. The device of claim 1, wherein the monitoring unit monitors a result of a previous process and a state of a current process for the semiconductor package so as to adjust a preset subsequent process condition by tracking a position of the semiconductor chip using the terahertz wave.

13. A method for monitoring a semiconductor packaging process using a terahertz wave, the method comprising:
generating terahertz waves toward a semiconductor package;
detecting terahertz waves reflected from the semiconductor package or terahertz waves transmitting through the semiconductor package; and
monitoring a state of the semiconductor package in real time based on the terahertz waves detected in the detecting of the terahertz waves, during the packaging process for the semiconductor package, wherein
the state of the semiconductor package includes at least one of a misalignment due to two-dimensional translation of a semiconductor chip, a misalignment due to two-dimensional rotation of the semiconductor chip, a deformation due to three-dimensional tilting of the semiconductor chip, and a deformation due to a three-dimensional warpage of the semiconductor package.

14. The method of claim 13, wherein the semiconductor package has at least one detection point set at which the terahertz wave is detected, and the at least one detection point includes at least one border point set on a border of the semiconductor chip, wherein
the monitoring monitors the state of the semiconductor package in real time through one monitoring process selected from among:
a first monitoring process for monitoring in real time a presence of the misalignment due to the two-dimensional translation of the semiconductor chip;
a second monitoring process for monitoring in real time a presence of the misalignment due to the two-dimensional rotation of the semiconductor chip;
a third monitoring process for monitoring in real time a presence of the deformation due to the three-dimensional tilting of the semiconductor chip; and
a fourth monitoring process for monitoring in real time a presence of the deformation due to the three-dimensional warpage of the semiconductor package, wherein
when the one monitoring process among the first to fourth monitoring processes is selected, a detection position and a detection number for the at least one detection point are automatically defined.
